(19) United States
(12) Patent Application Publication
(10) Pub. No.: US 2009/0116488 A1
(43) Pub. Date: May 7, 2009

(54) METHOD FOR DISTRIBUTING TRAFFIC BY MEANS OF HASH CODES ACCORDING TO A NOMINAL TRAFFIC DISTRIBUTION SCHEME IN A PACKET-ORIENTED NETWORK EMPLOYING MULTI-PATH ROUTING

(75) Inventors: Gero Schollmeier, Gauting (DE); Christian Winkler, Munchen (DE)

Correspondence Address: K&L Gates LLP, P.O. BOX 1135, CHICAGO, IL, 60690, US

(73) Assignee: Nokia Siemens Networks GmbH & Co KG, Muenchen (DE)

(21) Appl. No.: 12/352,149

(22) Filed: Jan. 12, 2009

Related U.S. Application Data
(63) Continuation of application No. 10/559,118, filed on Dec. 2, 2005.

(30) Foreign Application Priority Data
Jun. 3, 2003 (DE) 103 25 016.6

(51) Int. Cl. H04L 12/56

(52) U.S. Cl. 370/392

(57) ABSTRACT

Hash-code value ranges are determined for a traffic distribution among the nodes along a multipath route in a packet-oriented network, according to a predefined traffic distribution in the network. Starting from one or more start nodes, the traffic distribution is determined successively as a function of the hash-codes along the multipath route for each node, including branches, and an allocation of value ranges for the hash-codes to the outbound links is defined. The advantage is that it enables a desired distribution of traffic along any number of multipath routes by distribution on the basis of hash-codes.

### CROSS REFERENCE TO RELATED APPLICATIONS

This application is the U.S. National Stage of International Application No. PCT/EP2004/050971, filed Jun. 1, 2004 and claims the benefit thereof. The International Application claims the benefits of German application No. 10325016.6 DE filed Jun. 3, 2003, both of the applications are incorporated by reference herein in their entirety.

### FIELD OF INVENTION

The invention relates to a method and a node for specifying traffic distribution for nodes in a packet-oriented network formed with nodes and links and employing multi-path routing.

### BACKGROUND OF INVENTION

The development of methods for the transmission of real-time traffic, such as, for example, voice traffic, over packet-oriented networks is a central field of activity for network specialists, switching systems engineers and internet experts.

Circuit-switched networks and packet-based data networks coexist at the present time. Out of economic considerations it is desirable for voice and data to be transmitted over a standardized network. For the commonest type of packet-oriented networks, which are based on the Internet Protocol and consequently are also called IP networks, various protocols or, as the case may be, methods have been developed which are designed to permit a voice transmission over IP networks with the voice quality familiar from conventional networks. At the same time a number of inadequacies of the original IP networks in relation to the transmission of real-time traffic (e.g. voice) need to be overcome.

Conventional IP networks transport data packets according to a “best effort” approach. Data packets are forwarded through nodes or routers on the basis of the destination addresses contained in the packet header. Routing decisions are local. The individual nodes operate autonomously. The quality of the transmission of packets is critically dependent on the conditions in the nodes passed in the course of the transmission. For example, with overloaded nodes considerable delays can occur and this can even lead to packets being discarded, as a result of which the quality features of a voice transmission cannot be guaranteed.

One possibility of reducing the susceptibility to constrictions or bottlenecks in the transmission path and of improving the distribution of the traffic is to transmit the traffic over more than one path. With the ECMP (Equal Cost Multi Path) concept, which is defined within the framework of the OSPF (Open Shortest Path First) standard, it is provided to transmit traffic over a plurality of paths that are equal in length in terms of a distance function or, as the case may be, are subject to the same costs (a method referred to as “least cost routing” is often carried out).

One of the following two strategies is typically employed for distributing traffic along these paths:

1. Distribution by packet: The packets are distributed individually onto the outputs (e.g. using what is termed a weighted round-robin strategy). Although this results in an optimal and deterministic distribution of the traffic, it leads to transpositions in the order of the packets of a communication session because the packets then take different paths before they arrive at the destination.

2. Distribution by flow: The traffic is distributed on the basis of traffic flows, with the result that the packets of a communication session all take the same output. In this case, however, the granularity or fineness of the traffic distribution is poorer, and the freedom in choosing a path when assigning a packet to a path is limited by the flow association. On the other hand, this strategy ensures the original packet sequence is retained within each communication session.

The flow concept is often defined in this context in the sense that packets with matching source address information and destination address information (e.g. IP addresses or IP addresses together with port numbers) are assigned to the same flow.

To achieve a practicable and scalable implementation of the second variant, i.e. distribution by flows, use is commonly made of hash codes. A hash code, in the present context, is a number generated by a hash function in the value range of the hash function. A hash function maps a string or a numeric sequence to a fixed value range or to a bit sequence having a fixed length. Hash functions are frequently also used for cryptographic methods. At the time of the distribution onto different paths a hash code is generated from the header of the IP packets (e.g. the source and/or destination address). Said hash code then determines the traffic distribution. When source and destination address are used as the input value for the hash code calculation, all packets of a source-destination communication session or, as the case may be, of a flow are automatically assigned the same hash code and consequently are routed to the same output. Methods are known which ensure that these hash codes are evenly distributed over the permitted range of the hash codes. Methods of said kind are described for example in the publication titled “Performance of hashing-based schemes for Internet load balancing” by Z. Cao, Z. Wang and E. Zegura, which was published in the Proceedings of the IEEE Conference on Computer Communications (IEEE Infocom 2000), New York, in March 2000.

More recent concepts tend toward providing a more flexible traffic distribution than in the ECMP concept. Two key aspects of this more flexible distribution are:

In contrast to ECMP, where a fixed allocation to non-branching paths is provided between two points, a routing along branching multi-path routes or multi-path paths is to be allowed. In the ideal case the distribution can be performed here autonomously by the nodes, i.e. the local distribution of flows onto links is not determined globally.

An increased autonomy of the individual nodes in respect of the routing decisions is also important with regard to a fast response to faults (e.g. link failure). In contrast to the ECMP method, in which a redefinition of all the paths would have to be carried out in response to a fault, the aim is to allow a local change to multi-path routes.

With extensions of this kind aimed at flexible multi-path routing, an inherent difficulty of the method arises in the use of bash codes for distributing the traffic. A basic problem of the hash method described is that nodes deliver the packets according to hash codes to the outputs of the links leading away from the node (the links associated with a multi-path route are also referred to below as route fan-outs) and so are therefore sorted by hash codes. If the same function for generating hash codes is applied again to the packets in the succeeding node connected to an output, the result can no longer be evenly distributed. Rather, the function will only produce the value range of the hash codes already anticipated by the sorting in the preceding node. This means that an efficient distribution of traffic is no longer guaranteed.

In the most general case the individual paths of a multi-path fanout are not necessarily routed disjointly end-to-end in an IP network employing multi-path routing. It therefore happens that in network nodes traffic converges which was already distributed previously on the basis of hash codes and was therefore sorted (thus, not only are packets sorted according to their hash codes during distribution in the nodes, but said sorted packet streams are also merged). More often than not this leads to rough deviations from the even distribution in said node, with the result that a desired distribution of the traffic onto outgoing links of a multi-path route fan-out is therefore no longer guaranteed.

### SUMMARY OF INVENTION

An object of the invention is to specify a method which enables a traffic distribution by means of hash codes for any multi-path routing methods.

The object is achieved by the claims.

According to the invention, starting from one or more start nodes (e.g. edge nodes of the network) a multi-path route is successively taken and depending on a desired traffic distribution (i.e. a distribution of the traffic in the network) or, as the case may be, traffic allocation (i.e. a distribution of the traffic among the nodes) node-related value ranges of the hash codes are determined which guarantee a traffic allocation corresponding to the nominal traffic distribution. In this case a start node is characterized in that the traffic volume distribution is known as a function of the hash codes which are determined in the course of the transport of packets associated with flows over the multi-path route. On the basis of the known traffic volume distribution by the start node(s), the traffic volume distribution for the succeeding nodes can be determined as a function of the hash codes and value ranges can be specified for the distribution of the traffic in line with the nominal traffic distribution scheme. In this way value ranges of the hash codes and an assignment of these value ranges to links for the traffic distribution corresponding to the nominal distribution of the traffic can be specified node by node along the multi-path route. The total volume of the traffic routed over a link results here through integration of the traffic volume of the hash code value ranges which are assigned to the link. The nominal distribution can be determined for example by means of traffic models or, as the case may be, a traffic matrix.

By means of the inventive method a (deterministic) traffic distribution in accordance with a nominal traffic distribution in the network can be specified for any multi-path routes with traffic distribution on the basis of hash codes. In this scheme each outgoing link, for example, can be assigned a value range. A possible distortion through use of the same hash function for succeeding nodes is avoided by the definition of hash code value ranges in accordance with the nominal traffic distribution. With the method according to the invention the packets of the same flow generally follow the same path, thereby avoiding additional overhead for a re-sorting of packets (also referred to as “resequencing”).

It is favorable for the calculation of value ranges of the hash codes if the traffic volume density is evenly distributed in the start node or start nodes as a function of the hash codes. Hash codes are calculated for example on the basis of address information, e.g. a source and destination address or 2-tuples formed from source address and port number as well as destination address and port number which identify the flow.

### BRIEF DESCRIPTION OF THE DRAWINGS

The subject matter of the invention will be described in more detail below within the context of an exemplary embodiment with reference to figures, in which:

FIG. 1: shows a network section comprising nodes and links

FIG. 2: shows a traffic distribution via hash codes at node A and a traffic distribution at node B

FIG. 3: shows the aggregated traffic in node C

FIG. 4: shows the traffic integrated via the hash codes

### DETAILED DESCRIPTION OF INVENTION

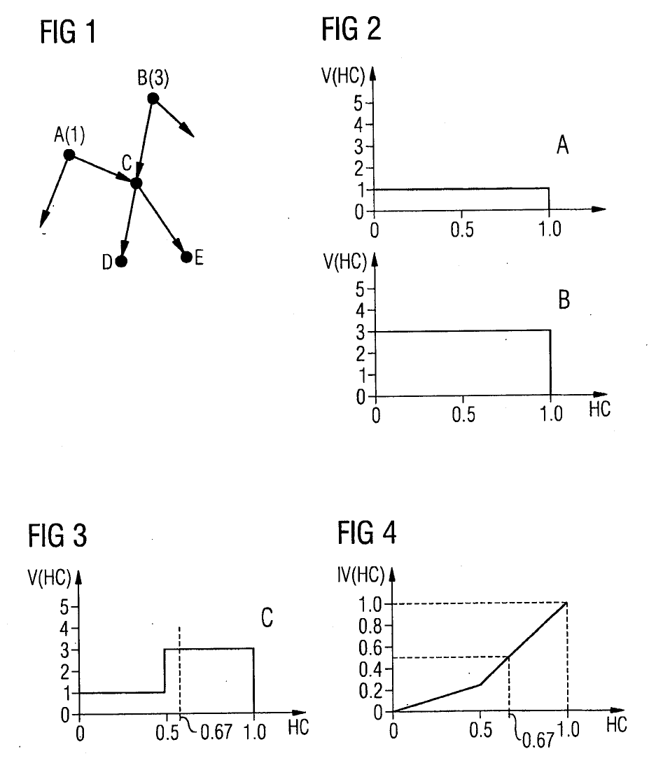

FIGS. 1-4 illustrate the difficulties in the conventional case and show how this problem is solved according to the invention.

FIG. I shows a network section comprising the nodes A, B, C, D and E and several links represented by arrows. The numbers after the node identification A and B indicate the relative traffic volume that these nodes deliver into the network, i.e. three times as much traffic runs via node B as via node A. FIG. 2 shows the evenly distributed traffic at node A (top) and node B (bottom). The abscissa designates the hash codes HC, which in a normalized representation should lie in the range 0 . . . 1. The ordinate indicates the traffic density V (HC), so the curve describes the (normalized) distribution of the traffic via the hash codes HC. The integral, i.e. the area under the rectangular curve, corresponds to the traffic volume of the respective node. FIG. 3 shows the traffic resulting in node C if the traffic is distributed in A and B half and half onto the two drawn links as follows: In each case the traffic with hash codes <=0.5 is sent from A to C and the traffic with hash codes HC 0.5<hash code<=1 is sent from B to C. It is self-evident that the hash codes HC of the traffic in node C is therefore no longer evenly distributed. The desired distribution of the traffic from C to D and E is no longer guaranteed if an even distribution is assumed for the distribution of the traffic by node C.

According to the invention, starting from nodes A and B of the multi-path route:

A) in a first step the resulting distribution of the traffic volume via the hash codes HC is calculated in the succeeding node C from the traffic volume and the specified nominal distribution weights.

B) is determined in a second step by (piece-by-piece) integration of this distribution, where the hash code limits are to be set in the node under consideration in order to reach the desired nominal distribution weight. If w is the desired distribution weight and IV(HC) the cumulative or, as the case may be, integrated distribution, normalized to 1, of the traffic volume V (HC) via the hash codes HC, then

w=V(HC1)−V(HC2)

where HC1 . . . HC2 is the range of the hash codes that are routed to the output which is to be assigned the weight w. If only two outputs are used, then HC1 is always equal to the minimum hash code HC_min occurring for the lower portion and always equal to the maximum hash code HC_max occurring for the upper portion HC2. If the traffic is to be distributed over more than two links, then the values of HC1 and HC2 must be calculated successively for the links, beginning with HC_min or HC_max.

FIG. 3 shows the resulting cumulative distribution of the traffic volume via the hash codes in node C. Also shown in the drawing is the limit HCD=0.67 (relative to the hash codes HC normalized to 1) which must be set in C in order to achieve a half-half distribution onto the links to D(WD=0.5) and E(WE=0.5). For comparison: In nodes A and B, HCD=0.5 was to be set for a half-half distribution. FIG. 4 shows the integrated traffic IV(HC) in node C, with the entire traffic normalized to 1. It results from the figure that the limits of the hash code value ranges need to be fixed for HC_min=0 and HC_max=0.67 or, as the case may be, at HC_min=0.67 and HC_max=1 in order to set an even distribution of the traffic routed via node C onto the two succeeding nodes D and E.

The steps one and two described for node C can be performed successively for all nodes along the multi-path route until the destination node is reached (the method thus “travels through” the multi-path route).

The result is the hash code limits to be set at the node edges for the desired nominal traffic distribution weights for each node in the multi-path route.

1-4. (canceled)

5. A method for specifying the traffic distribution for a first node in a packet-oriented network using a multi-path routing, the packet-oriented network including the first node, a start node, a further node, and links, the method comprising:
distributing traffic for the first and start nodes onto at least two outgoing links in accordance with a hash code generated using an address information in a network packet of the traffic;
specifying a nominal distribution of the traffic to be routed along a multi-path route; and
starting from a start node of the multi-path route along the multi-path path for at least one path node with at least two outgoing links in the multi-path route, the path node selected from the group consisting of: first node, start node, and combinations thereof:
determining the distribution of the traffic routed to the path node on the multi-path route, the distribution determined as a function of a value range of the hash codes on the basis of the traffic routed from preceding nodes to the respective node, and
specifying in accordance with the nominal distribution of traffic, an assignment of value range sections of the hash codes to the outgoing links of the multi-path route.

6. The method according to claim 5, wherein the hash codes in a start node are evenly distributed in their range value.

7. The method according to claim 6, wherein the hash codes are generated from a source address and a destination address.

8. The method according to claim 7, wherein one value range section is assigned to each outgoing link.
